(19) United States
(12) Patent Application Publication
(10) Pub. No.: US 2012/0102433 A1
(43) Pub. Date: Apr. 26, 2012

(54) Browser Icon Management

(76) Inventor: Steven Jon Falkenburg, Los Altos, CA (US)

(21) Appl. No.: 12/908,795

(22) Filed: Oct. 20, 2010

(51) Int. Cl. G06F 3/048

(52) U.S. Cl. 715/835

(57) ABSTRACT

Methods, systems and machine readable tangible storage media that can present a web site offering a service via a web browser to receive persistent code from the web site are described. The persistent code may be installed in association with the web site in a manner hidden from a user of the browser. Activities of the service of the web site may be monitored in a background operation by running the persistent code. When interested activities are discovered by the persistent code, a notification may be presented in a user interface via an icon representing the service. The browser may be activated to browse the web site for receiving the service via the icon presented.

### BACKGROUND OF THE INVENTION

With the growth of web based services, it has become increasingly popular to access a variety of services using a single web browser, such as Safari from Apple Inc., running in a data processing system. A user can direct the web browser to browse a particular web site for a particular service. For example, the user may go to a facebook.com web site for exchanging messages with buddies via the browser and switch to me.com web site for checking email messages via the same browser. Typically, the browser may open, for each window of the web browser, one web site at a time. However, multiple web based services offered from different web sites may be ongoing even when not accessed by web browsers. In other words, these services can have notifications that would be received if a web browser was directed to access the service by a user. As a result, new updates related to a service to which the user subscribes will not be available to the user before the user visits the web site.

Many utilities or user interface short cuts have been provided to help a user switch between different web sites using a web browser. For example, a browser favorites list or menu may allow a user to organize frequently visited web sites. Browser tabs may be provided to facilitate loading multiple websites simultaneously. Alternatively, a browser extension may enable the user to customize a browser user interface to tailor a browser for the user's specific usage pattern or habits. However, it is still required for the user to command the browser to visit a web site to access a service the web site offers. In addition, opening multiple windows or browser tabs may consume a large amount of memory resources. Furthermore, as the number of web based notification services increases, it is inconvenient to explicitly visit each web site for receiving timely updates or notifications from the large number of web based services.

Therefore, traditional browsers do not provide a convenient mechanism to allow a user to receive timely and up to date notifications for web based services.

### SUMMARY OF THE DESCRIPTION

Methods, machine readable tangible storage media, and data processing systems that can present previews of content are described.

In one embodiment, persistent code can be running in the background of a data processing system subsequent to a browser browsing to a web site to poll the web site for alerts or notifications of new activities in a service offered by the web site. Accordingly, a user interface feature may be modified and/or exposed to direct a user's attention for launching the web browser directly back to the web site. The user interface feature can be based on icons, such as dock icons, in a screen region outside of user interface elements directly controlled by the web browser. The dock is an example of a screen region that can be used to, for example, launch applications, quit applications, switch between applications or switch between windows of an application. Thus, activities in the web site can be monitored without a need for the user to cause the web browser to present the web site. The user can be notified of changes on the service provided by the web site (e.g. a chat request though facebook.com account or arrival of new emails on me.com account, etc.) while browsing other web sites or performing other user interface activities via applications other than the web browser. Separate user interface icons, each to activate the common web browser application, may be presented as if representing separate standalone applications for various services offered by different web sites.

In another embodiment, instructions can be received from a web site via a browser for installing a site specific notification service. The instructions may be based on script (e.g. JavaScript) codes downloaded and/or installed as a result of the user browsing the web site. The user, in one embodiment, may not be aware of the download and/or installation of the instructions. Once installed, the instructions may be automatically invoked continuously or periodically to poll the web site for monitoring activities in the web site regardless of whether a browser is currently active and regardless of which web site an active browser is currently browsing. When receiving a notification of activities or something new from the web site, the instructions may cause a presentation of the notification via a user interface, such as creating a dock icon for the web site and/or updating an existing dock icon of the web site to draw the user's attention. In one embodiment, the dock icon may be actionable to direct the browser to the web site or to activate (e.g. launch) the browser to the web site when receiving an input from the user (e.g. clicking on the dock icon, a keyboard action, or a touch gesture).

In another embodiment, a set of API (application program interface) calls may be provided for script codes retrieved from web sites for monitoring site specific services. Security and privacy policies may be imposed to restrict the script codes from one web site to access only web resources belonging to the domain of the web site, such as URLs (universal resource locator) of the domain. The script codes may be prohibited from accessing system resources without calling the set of APIs provided. In one embodiment, the set of APIs can manage a user interface outside of a browser, such as a dock icon managed by a dock application which is separate from a browser application. For example, a dock icon on a display screen may be added, animated or badged for the web site by the dock application. The script codes may call the APIs to interface with the dock application directly or indirectly via the browser. User preferences may be communicated to the script codes to manage (e.g. remove/add/update) the dock icon via a preference menu based on the APIs directly from the dock application or indirectly via the web browser application.

Another embodiment of the present invention can include methods and apparatuses that present a web site offering a service via a web browser to receive persistent code from the web site. The persistent code can be installed in association with the web site in a manner hidden from a user of the browser in one embodiment. Activities of the service of the web site may be monitored in a background operation by running the persistent code. When interested activities are discovered by the persistent code, a notification may be presented in a user interface via an icon representing the service. The browser may be activated to browse the web site for receiving the service via the icon once it is presented.

Another aspect of the present invention relates to storing script code received from a remote web site providing a service via a browser browsing the web site. Resources accessible by the script code may be limited or restricted within a domain of the remote web site. The script code can include a schedule for execution to generate a UI (user interface) indication for activities of the service from the remote web site. The UI indication may be presented via a selectable icon; this icon invites a user, in effect, to browse the web site.

The above summary does not include an exhaustive list of all aspects of the present invention. It is contemplated that the invention includes all systems, methods and machine readable storage media which can cause a system to perform any one of these methods that can be practiced from all suitable combinations of the various aspects summarized above, and also those disclosed in the Detailed Description below.

### BRIEF DESCRIPTION OF THE DRAWINGS

The present invention is illustrated by way of example and not limitation in the figures of the accompanying drawings in which like references indicate similar elements.

FIG. 1 illustrates an exemplary user interface including dock icons managed for a browser according to one embodiment of the present invention;

FIG. 2 is a block diagram illustrating an exemplary architecture for one embodiment of the present invention which may be implemented in software;

FIG. 3 is a block diagram illustrating an exemplary system for one embodiment of the present invention;

FIG. 4 is a flow diagram for monitoring a web site to update an icon representing activities of a service discovered from the web site according to one embodiment of the invention;

FIG. 5 is a flow diagram for securely executing a persistent code loaded from a web site via a browser to present a UI indication for activities of a service offered by the web site via the browser;

FIG. 6 shows, in block diagram form, an example of a data processing system which can be used with one or more embodiments described herein.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

Some embodiments include one or more application programming interfaces (APIs) in an environment with calling program code interacting with other program code being called through the one or more interfaces. Various function calls, messages or other types of invocations, which further may include various kinds of parameters, can be transferred via the APIs between the calling program and the code being called. An API may receive parameters as disclosed or other combinations of parameters. An API may also implement functions having parameters, variables, or pointers. In addition, an API may provide the calling program code the ability to use data types or classes defined in the API and implemented in the called program code. Certain embodiments may include an environment with a calling software component interacting with a called software component through an API. A method for operating through an API in this environment includes transferring one or more function calls, messages, other types of invocations or parameters via the API. In addition to the APIs disclosed, other APIs individually or in combination can perform similar functionality as the disclosed APIs.

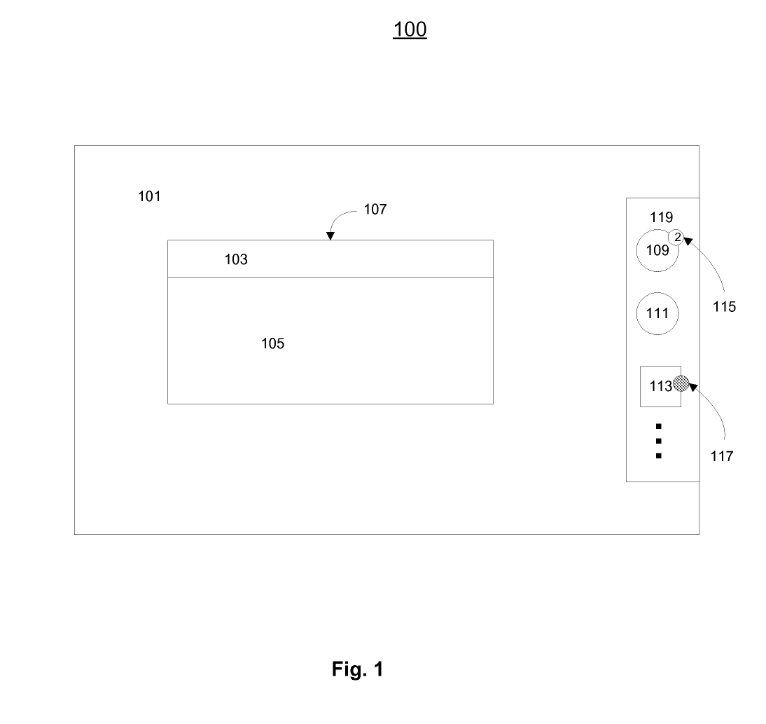

FIG. 1 illustrates an exemplary user interface including dock icons managed for a browser according to one embodiment of the present invention. Interface 100 may include a display area 101 presenting user interface elements, including windows, icons, menus, tool bars, buttons, text boxes or other application display elements providing user interface functionalities via a display screen. Display area 101 may correspond to a display screen which can be a liquid crystal display or other display device displaying the user interface, such as a desktop computer monitor or a mobile communication device. In one embodiment, display area 101 can display one or more windows for one or more programs. For example, browser 107 may correspond to a window opened for a browser application browsing a web site presented in a browsing area 105. Browser 107 may include address bar 103 indicating a URL addressing the web site currently being browsed or displayed via browsing area 105. Typically, display elements (e.g. a pixel or other display units of a display screen) within a window opened for an application can be directly accessible by the application (e.g. the application can perform graphic operations on the display elements within the window). The application may not access display elements associated with other applications, i.e. outside of the application.

Display area 101 can include icons placed in dock 119 which may be an example of a program control region disposed on or near an edge (e.g. top, left, right or bottom edge) of a display screen. Dock 119 can include icons 109, 111, 113 representing application programs which can be launched, activated or otherwise controlled from dock 119. The word “dock”, as used in this description, will be understood to include the dock in the user interface of the Macintosh OS X operating system from Apple Inc. of Cupertino, Calif. and will be understood to also include a control display region, such as a screen region at a border of a display screen, which has selectable regions (such as selectable texts or tabs or other types of icons) that can be used to launch one or more applications or switch between applications or switch between windows of one or more applications (for example, the selectable regions can be used to switch the front most window from a first window of a first application program to a second window of a second application).

For example, icon 109 may be an example of a browser application to browse a specific web site directly (e.g. without waiting for additional instructions from a user), e.g. facebook.com, when launched. Icon 111 may correspond to an example of a browser application to open a home page when launched. Similarly, icon 113 may be another example of the browser application to browse a separate web site, e.g. gmail.com, and activate a service, e.g. email server, provided by the web site. Additional icons for applications other than a browser may be displayed in dock 119. In some embodiments, additional dock icons associated with websites may be added to dock 119. A background service written in JavaScript may control whether a dock icon is visible, badged, bouncing and which URL would be taken to if the dock icon is clicked. Display elements inside dock 119 can be managed via a system program (e.g. a dock application) which is separate from a browser application, and, in one embodiment, the content of the dock is not directly accessible by other applications (e.g. the browser application).

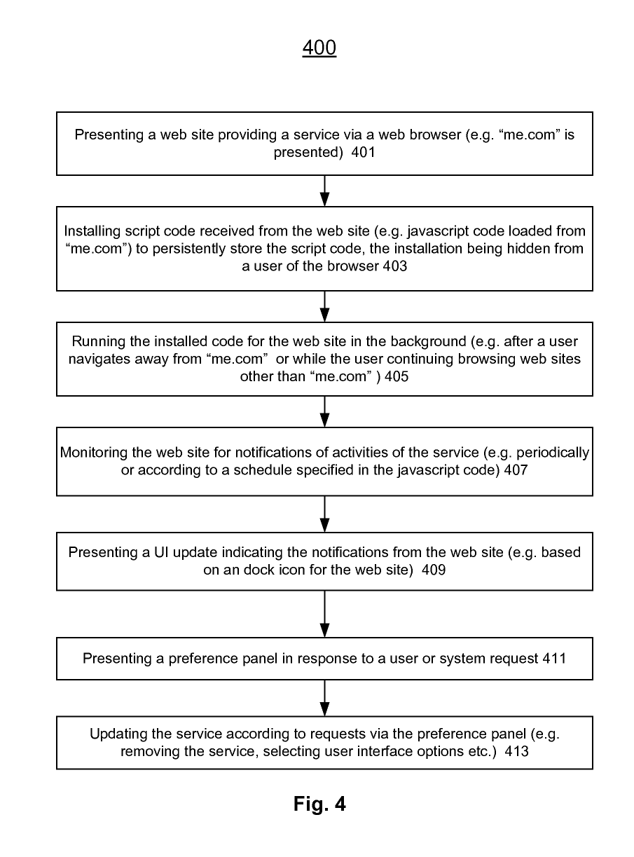

In one embodiment, badges 115, 117 may indicate activities, such as chat requests or new emails, discovered in the background (e.g. without being indicated in the foreground of screen 101) from corresponding web sites for icons 109, 113 respectively. The discovery of these activities can, in one embodiment, be performed with operations 405, and 407 in FIG. 4. Badges may be displayed with summary information, signs, special colors, shapes or other applicable user interface designs to represent the activities discovered, such as number of unread messages, number of chat requests, text data or other applicable information, etc. Alternatively, a badge may be presented in an animated manner, such as with bouncing, flashing, swelling/shrinking, changes in colors, changes in shapes, other applicable animation effects, or a combination of different animation effects, etc. Appearances of badges 115, 117 may, for example, attract attention of a user to icons 109, 113 on the occurrences of interesting events associated with icons 109, 113 (e.g. activities notified from corresponding web sites) while the user is browsing web sites unrelated to icons 109, 113 or performing other activities.

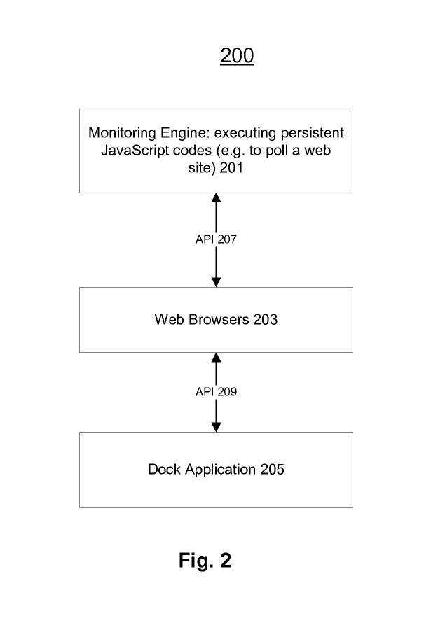

FIG. 2 is a block diagram illustrating an exemplary architecture for one embodiment of the present invention which may be implemented in software. For example, architecture 200 can provide dock icons indicating notifications from different web sites for activating a browser to those web sites, such as in interface 101 of FIG. 1. Architecture 200 may include executable components stored in a storage area (e.g. a memory) in an operating environment of a device. The executable components may be running in the foreground via a display device to interface with a user of the device. Optionally, the executable components may be running in the background without being noticed by the user.

In one embodiment, monitoring engine 201 may execute script code (or other applicable code or executable binary code) received from a web site (e.g. downloaded by a browser) to mange notifications of a service offered by the web site. For example, in one embodiment, monitoring engine 201 can perform operations 405 and 407 in FIG. 4. The script code may include instructions originated from the web site registered in a browser to allow a UI update outside of the browser to present the notification. According to one embodiment, the script code may be persistently used with its associated web site. A browser may register multiple web sites to enable simultaneously monitoring (e.g. in the background) of these web sites regardless of which web site the browser is currently browsing or whether the browser is currently active (e.g. a browser window may be closed or minimized to become inactive). For example, a registry storage may store information about registered web sites to allow installation and/or execution of script codes received from the web sites.

According to an embodiment, monitoring engine 201 can invoke a script execution engine to execute each persistently stored script code, e.g. in turn for each associated web site. This stored code can be persistent in that it runs across launches of a web browser. For example, this stored code can be executing (for example, to poll for notification from a web site) while a web browser has been launched and is executing, and the user can quit the web browser or even shut down (e.g. turn power off) the system and when the web browser is launched again (after quitting or after shutdown) this code can be executing again. The script code may include manifest or specifications for a schedule to poll the corresponding web site to receive possible notifications. For example, the schedule may indicate the web site should be polled periodically for a specified period (e.g. to poll every five minutes). In some embodiments, monitoring engine 201 may be invoked according to an event service configured based on the schedule in the script code.

Monitoring engine 201 may execute script code to manage notifications of activities (e.g. polled) from a remote web site. In one embodiment, the script code may include APIs 207 calling web browser 203 for updating a user interface to indicate occurrences of the activities notified. Web browser 203 may be active running in the foreground. Alternatively, browser 203 may receive APIs 207 when running in the background, e.g. as an inactive application. APIs 207 may cause web browser 203 to be launched, if not currently running, e.g. for receiving user interface update requests from monitoring engine 201 executing the script code. Monitoring engine 201 may be running independently and/or separately from browser 203 (e.g. via different processes). In some embodiments, script codes executed in monitoring engine 201 may be limited to access only APIs 207 for security and privacy reasons.

Browser 203 may call dock application 205 to update a user interface in a dock region of a display area, such as dock 119 of FIG. 1, in response to calls, through the APIs, from monitoring engine 201. For example, dock application 205 may generate a dock icon in the dock region, remove an existing dock icon from the dock region, or may badge or animate an existing dock icon in the dock region to indicate activities notified from a remote web site.

Alternatively, a user may enter a preference to disable/enable appearances of dock icons for web sites via a user interface (e.g. via preference menus invoked when selecting a dock icon via commonly known user interface technologies using an input device, such as a mouse or keyboard). Thus, the user can control whether a dock icon for a web site should occupy a display real estate in a dock region of a screen display area. In one embodiment, dock application 205 may receive user's disable/enable preferences on a dock icon for a web site. Dock application 205 may notify monitoring engine 201 executing corresponding script code for the web site to update a setting for the user's preferences. In some embodiments, dock application 205 may send a user preference request to monitoring engine 201 via browser 203 according to APIs 207, 209.

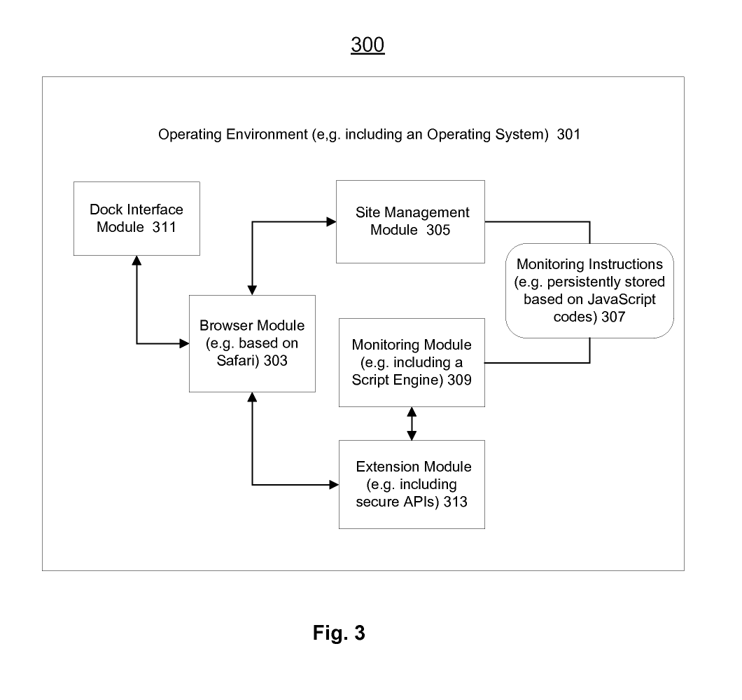

FIG. 3 is a block diagram illustrating an exemplary system for one embodiment of the present invention. For example, system 300 may be based on an operating environment 301 supporting dock icons for indicating notifications from services offered by web sites, such as in dock 119 of FIG. 1. System 300 may include monitoring instructions 307 persistently stored and used in a storage device (e.g. non-volatile memory or mass storage). Monitoring instructions 307 may be based on JavaScript codes received from web sites to monitor events happening related to the services offered from these web sites in a timely manner, e.g. the arrival of new emails for a web based email service.

In one embodiment, browser module 303 may visit (or connect to) a web site (e.g. as instructed by a user) to download script code to be persistently stored and used for monitoring the web site. Site management module 305 may register the web site to authorize the web site to send over the script code persistently stored in monitoring instructions 307 for execution. In one embodiment, site management module 305 can determine whether a web site is authorized for updating monitoring instructions 307, e.g. to add/delete/revise script codes stored therein.

According to one embodiment, monitoring module 309 may execute script codes stored in monitoring instructions 307 in the background to enable a web site to notify activities occurring in service offered by the web site via a user interface without a need for browser module 303 to browse the web site. Monitoring module 309 may invoke a script engine, such as a JavaScript engine shared with browser module 303 to execute script codes. In one embodiment, monitoring module 309 may execute each script code associated with a separate web site via the script engine periodically to ensure timely notifications are received for each web site. Monitoring module 309 may parse a manifest stored with or within the script code for scheduling when to execute the script code. The schedule in the manifest can specify how often the code runs, when it can run and how often it polls one or more web sites.

In one embodiment, execution of script code may be based on extension module 313 linked or accessible via monitoring module 309. Extension module 313 may allow monitoring module 309 to contact (or make web connections to) web sites associated with the script code currently being executed. Alternatively, extension module 313 can enable monitoring module 309 to update a user interface according to notifications received from web sites. For example, extension module 313 may forward UI request to dock interface module 311 to manage dock icons associated with web sites, such as in dock region 119 of FIG. 1. Extension module 311 may route UI request indirectly to dock interface module 311 via browser module 303. Dock interface module 311 may provide UI services to manage dock icons displayed in a display area (e.g. a desktop area) of a display screen.

Monitoring module 309 may be running in a process independent of or separate from browser applications for browser module 303 or other application programs. In one embodiment, monitoring module 309 may be restricted to call only APIs in extension module 313. The APIs in extension module 313 may allow monitoring module 309 to call dock interface module 311 for supporting different ways of updating dock icons (e.g. preconfigured manners for animating or badging dock icons). In one embodiment, the APIs in extension module 313 may have limited resource access capabilities to ensure privacy and security protection. For example, extension module may block a call from script code to access resources other than from a domain (e.g. of an URL) belonging to a web site associated with the script code persistently stored in monitoring instructions 307.

FIG. 4 is a flow diagram for monitoring a web site to update an icon representing activities of a service discovered from the web site according to one embodiment of the invention. Exemplary process 400 may be performed by a processing logic that may comprise hardware (circuitry, dedicated logic, etc.), software (such as is run on a dedicated machine), or a combination of both. For example, process 400 may be performed by some components of system 300 of FIG. 3. In one embodiment, at block 401, the processing logic of process 400 may present a web site which provides a service (e.g. an email service from me.com or a notification service from facebook.com, etc.) via a web browser. The web browser may be directed to the web site, e.g. by a user (e.g. via UI operations such as entering a URL, clicking a hyperlink, etc.) or by other automatic mechanisms to establish a network connection between the browser and the web site.

At block 403, the processing logic of process 400 may install script code, e.g. based on Javascript language, received from a web site for continuously or periodically monitoring notifications of the service offered by the web site (e.g. new mail notification of email service from “me.com”). The processing logic of process 400 may receive the script code over network connections established with the web site while a browser visits the web site. The installation can persistently store and use the script code for execution. In one embodiment, the user browsing the web site may not be aware of the installation or the retrieval of the script code. Optionally, the user may be notified with a message prompt about the installation or a permission request for the installation. The browser may be configured, e.g. via a preference interface, to register web sites for installing persistent codes. The processing logic of process 400 may ignore script codes received (or reject to receive script codes) from web sites not yet registered for installing and executing persistent codes.

At block 405, the processing logic of process 400 can execute or run the installed code for an associated web site in the background. For example, the execution of the installed code may be hidden from a user of a browser or other applications. The processing logic of process 400 may execute the installed code independent on whether the browser is currently active or which web sites the user is currently visiting. The user may completely navigate away from the associated web site (e.g. neither opened in a background tab nor other windows) when the installed code runs. In one embodiment, multiple script codes may be installed or stored separately for corresponding web sites. The processing logic of process 400 may periodically invoke a script execution engine to execute the installed codes in turn or simultaneously (e.g. via multi threads or processes).

In one embodiment, at block 407, the processing logic of process 400 may execute script code to monitor activities of the service offered in an associated web site for the script code. Each script code may specify an execution schedule for the corresponding web site. For example, the schedule may include a period (e.g. 5 minutes) for periodic execution or other date/time designations. In one embodiment, execution of the script code may establish a network connection to the web site for receiving updates on activities related to a service or an account associated with the service from the web site. In one embodiment, the processing logic of process 400 can match a domain of the network connection with the web site associated with the script code. The network connection may not be established if the domain does not match the web site to prohibit the script code from accessing unauthorized resources. In one embodiment, the processing logic of process 400 may forward identifiers for a client account (e.g. an email account for a user of a browser) to the web site to retrieve timely notifications on latest activities related to the client account (e.g. number of unread emails).

At block 409, the processing logic of process 400 may present a UI update indicating notifications from a web site. The UI update may be related to presenting a dock icon in a dock area, such as dock 119 of FIG. 1, generating a badge for the dock icon, animating the dock icon, and/or other application visual or sound effects to attract a user's attention to the service of the web site. A user can then see the notification and cause a web browser to access the associated web site by selecting the indication of the notification (for example, by selecting a badged icon on the dock), and this selection causes the web browser to be directed to the URL (specified in the notification or previously stored in the system) of the web site associated with the notification. In one embodiment, the processing logic of process may call APIs to access a browser from the script code executed for the web site for the UI update. The APIs may allow reset of a dock icon, such as removing the dock icon, stopping an animation effect on the dock icon, removing a badge on the dock icon, or terminating other applicable multimedia effects on the dock icon. For example, the processing logic of process 400 may reset a dock icon for an email service if no new messages are found in the email service.

At block 411, in one embodiment, the processing logic of process may present a preference panel (e.g. in a display screen) in response to a user or system request to manage background notification services for web sites. For example, the preference panel may be presented in response to user action on dock icons displayed in dock area, such as dock 119 of FIG. 1. At block 413, the processing logic of process 400 may update the background monitoring service according to users requests received via the preference panel. The preference panel may allow a user to disable script code installed for a web site associated with a dock icon identified by the user action (e.g. mouse clicking or inputs via a touch screen). In some embodiments, the script code may be removed from a persistent storage on user's requests to terminate monitoring the web site. Alternatively, the preference panel may allow the user to selection different user interface options to customize presentations of a dock icon, e.g. related to shapes, colors, sound, animation effects, types of badges, etc.

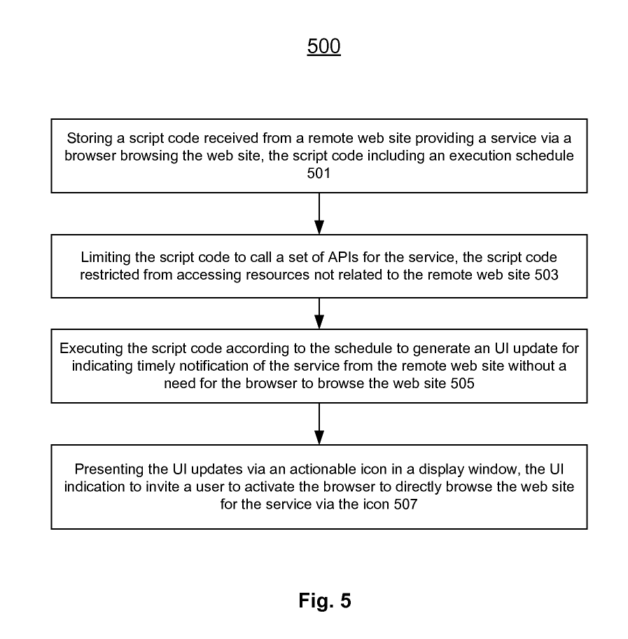

FIG. 5 is a flow diagram for monitoring a web site to update an icon representing activities of a service discovered from the web site according to one embodiment of the invention. Exemplary process 500 may be performed by a processing logic that may comprise hardware (circuitry, dedicated logic, etc.), software (such as is run on a dedicated machine), or a combination of both. For example, process 500 may be performed by some components of system 300 of FIG. 3. In one embodiment, at block 501, the processing logic of process 500 may persistently store and execute script code received from a remote web site via a browser while browsing the web site. The web site may provide a service via the browser. The script code may include a schedule for execution.

At block 503, the processing logic of process 500 may limit access rights of the script code for security and privacy protection. In one embodiment, the processing logic of process 500 may link the script code with a preconfigured module including a set of APIs the script code is permitted to call when executed. For example, the APIs may allow the script code to access URLs with a domain of the associated web site. The APIs may prohibit the script code to access resources (e.g. processing resource, network resources, memory resources etc.) not related to the associated web site. In one embodiment, the APIs may include management of user interface resources outside of a browser for generating a generic desktop UI element, such as via a dock icon, for notifications received from the web site.

At block 505, the processing logic of process 500 may invoke a script engine, such as a Javascript engine, to execute the installed script code in the background according to a schedule specified in the code. The invocation may not require that a browser is running nor a running browser browses the web site. A user of the browser may not be aware of the execution of the script code nor the invocation mechanism. The processing logic of process 500 may retrieve timely notifications or other messages from the web site via calls to the set of APIs in the script code. UI updates may be generated to reflect or indicate the notifications or messages received from the web site. In one embodiment, at block 507, the processing logic of process 500 may call the APIs to present the UI updates via an actionable icon, such as dock icon in dock 119 of FIG. 1. The UI updates may invite the user to activate the browser to directly browse the web site for accessing the service (e.g. receiving new emails from a web based email service).

Any one of the methods described herein can be implemented on a variety of different data processing devices, including general purpose computer systems, special purpose computer systems, etc. For example, the data processing systems which may use any one of the methods described herein may include a desktop computer or a laptop computer or a tablet computer or a smart phone, or a cellular telephone, or a personal digital assistant (PDA), an embedded electronic device or a consumer electronic device.

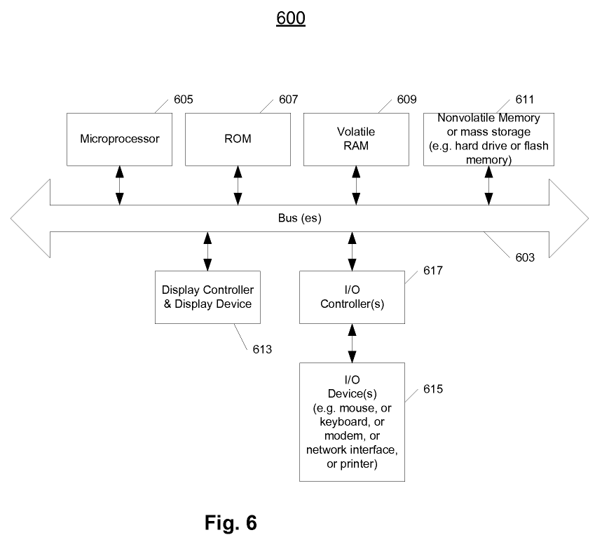

FIG. 6 shows another example of a data processing system which may be used with one embodiment of the present invention. Note that while FIG. 6 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention. FIG. 6 may represent the server system shown in FIG. 1.

As shown in FIG. 6, the computer system 600, which is a form of a data processing system, includes a bus 603 which is coupled to a microprocessor(s) 605 and a ROM (Read Only Memory) 607 and volatile RAM 609 and a non-volatile memory 611. The microprocessor 605 may retrieve the instructions from the memories 607, 609, 611 and execute the instructions to perform operations described above. The bus 603 interconnects these various components together and also interconnects these components 605, 607, 609, 611 to a display controller and display device 613 and to peripheral devices such as input/output (I/O) devices which may be mice, keyboards, modems, network interfaces, printers and other devices which are well known in the art. Typically, the input/output devices 615 are coupled to the system through input/output controllers 617. The volatile RAM (Random Access Memory) 609 is typically implemented as dynamic RAM (DRAM) which requires power continually in order to refresh or maintain the data in the memory.

The mass storage 611 is typically a magnetic hard drive or a magnetic optical drive or an optical drive or a DVD RAM or a flash memory or other types of memory systems which maintain data (e.g. large amounts of data) even after power is removed from the system. Typically, the mass storage 611 will also be a random access memory although this is not required. While FIG. 6 shows that the mass storage 611 as a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 603 may include one or more buses connected to each other through various bridges, controllers and/or adapters as is well known in the art.

The term “memory” as used herein is intended to encompass all volatile storage media, such as dynamic random access memory (DRAM) and static RAM (SRAM). Computer-executable instructions can be stored on non-volatile storage devices, such as magnetic hard disk, an optical disk, and are typically written, by a direct memory access process, into memory during execution of software by a processor. One of skill in the art will immediately recognize that the term “machine-readable storage medium” includes any type of volatile or non-volatile storage device that is accessible by a processor.

Portions of what was described above may be implemented with logic circuitry such as a dedicated logic circuit or with a microcontroller or other forms of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

In the foregoing specification, the invention has been described with reference to specific exemplary embodiments thereof. It will be evident that various modifications may be made thereto without departing from the broader scope of the invention as set forth in the following claims. The specification and drawings are, accordingly, to be regarded in an illustrative sense rather than a restrictive sense.

What is claimed is:

1. A machine readable, non-transitory, tangible storage medium storing executable instructions which cause a data processing system to perform a method comprising:
presenting a web site offering a service via a web browser to receive persistent code from the web site;
installing the persistent code associated with the web site;
monitoring the service in a background operation via the persistent code for activities of the service; and
presenting the notification via an icon representing the service in a user interface, the icon configured to activate the browser to browse the web site when the icon is selected.

2. The medium as in claim 1, wherein the installing is hidden from a user of the web browser and wherein the method further comprises:
registering the web site for the installation, wherein the persistent code is not installed if the web site is not registered.

3. The medium as in claim 1, wherein the installation comprises:
presenting the icon in the user interface, wherein the icon is presented in a dock area representing a program control region disposed on an edge of a display screen displaying the user interface.

4. The medium as in claim 1, wherein the persistent code includes a manifest that indicates a schedule to execute the persistent code, and wherein the monitoring is based on the schedule.

5. The medium as in claim 4, wherein the installation of the persistent code comprises:
storing the persistent code associated with the web site, the persistent code linked with a library to limit resource access by the persistent code.

6. The medium as in claim 5, wherein the monitoring comprises polls the web site to receive the notification via the library.

7. The medium as in claim 6, wherein the persistent code includes API (application programming interface) calls to the library for the resource access and wherein the library verifies the resource access against the web site via the API calls to prohibit the persistent code from accessing web sites other than the web site.

8. The medium as in claim 1, wherein the presentation of the notification updates the icon in the user interface to invite the user's attention to the notification from the web site corresponding to the icon.

9. The medium as in claim 8, wherein the update comprises animating the icon in the user interface.

10. The medium as in claim 8, wherein the update comprises generating a badge on the icon, the badge indicates a message of the notification.

11. The medium as in claim 1, further comprising:
in response to receiving an activation via the icon from the user for the web browser to browse the web site, removing the notification presented on the icon.

12. A machine readable, non-transitory, tangible storage medium storing executable instructions which cause a data processing system to perform a method comprising:
storing a script code received from a remote web site providing a service via a browser browsing the web site, the script code including a schedule;
limiting the script code from accessing resources other than the remote web site;
executing the script code according to the schedule to generate a UI (user interface) indication for the service from the remote web site; and
presenting the UI indication via a selectable icon in a display region, the UI indication to invite a user to present the service via the browser browsing the web site.

13. The medium as in claim 12, wherein the script code is received while the browser browsing the web site and wherein the script code is stored persistently associated with the web site.

15. The medium as in claim 12, wherein the storing comprises:
determining if the script code is authorized, wherein the script code is not authorized if the web site is not pre-registered.

16. The medium as in claim 12, wherein the limiting comprises:
linking the script code with a set of APIs (application program interface), wherein the script code is allowed to call only the set of APIs and wherein the APIs disable the script code from access the resources other than the remote web site.

17. The medium as in claim 16, wherein the UI indication is generated via one of the APIs, the one API managing a dock area in the display region to control activations of programs including the browser, the dock area including the actionable icon.

18. The medium as in claim 12, wherein the actionable icon represents the browser and wherein the UI indication indicates the service.

19. A machine implemented method comprising:
presenting a web site via a web browser to receive a service from the web site;
installing the service persistently associated with the web site, the installation being hidden from a user of the browser;
performing the service in a background operation unattended by the user to enable a notification for activities in the web site via a user interface; and
presenting the notification via an icon representing the web site in the user interface, the icon configured to activate the browser to browse the web site.

20. A machine implemented method comprising:
storing a script code received from a remote web site providing a service via a browser browsing the web site, the script code including a schedule;
limiting the script code from accessing resources other than the remote web site;
executing the script code according to the schedule to generate a UI (user interface) indication for the service from the remote web site; and
presenting the UI indication via a selectable icon in a display region, the UI indication to invite a user to present the service via the browser browsing the web site.
